(19) United States
(12) Patent Application Publication
(10) Pub. No.: US 2013/0204685 A1
(43) Pub. Date: Aug. 8, 2013

(54) SYSTEMS AND METHODS TO PROMOTE SALES IN INTERNET SOCIAL NETWORKING ENVIRONMENTS

(71) Applicant: Natura Cosmeticos S.A., Itapecerica da Serra (BR)

(72) Inventors: Marcio Orlandi, Sao Paulo (BR); Ana Carolina de Freitas Barroso, Recife (BR); Bruno Pereira da Encarnacao, Receife (BR); Fernando Jose de Aguiar Sodre, Recife (BR)

(73) Assignee: NATURA COSMETICOS S.A., Itapecerica da Serra (BR)

(21) Appl. No.: 13/757,302

(22) Filed: Feb. 1, 2013

Related U.S. Application Data
(60) Provisional application No. 61/594,456, filed on Feb. 3, 2012.

(51) Int. Cl. G06Q 50/00

(52) U.S. Cl. CPC G06Q 50/01; G06Q 30/0623
USPC 705/14.16; 705/26.61

(57) ABSTRACT

Various embodiments of the present invention concerns systems and methods to promote sales in internet social networking environments, wherein independent sales representatives (ISR) are preferentially made available or picked from within the closest social circle of the buyer.

### CROSS-REFERENCE TO RELATED APPLICATIONS

This application claims priority to and the benefit of U.S. Application No. 61/594,456 entitled, “Systems and Methods to Promote Sales in Internet Social Networking Environments” that was filed on Feb. 3, 2012, the entirety of which is hereby incorporated by reference herein.

### BACKGROUND

1. Field of the Invention

Various embodiments of the present invention concern systems and methods to promote sales in internet social networking environments, wherein independent sales representatives (ISR) are preferentially made available or picked from within the closest social circle of the buyer.

2. Description of Related Art

Internet social networking applications are known in the art, both online and mobile. Users typically create unique personal profiles that include basic information including identity, interests, profession, history, testimonials, likes and dislikes and information about their network. Users map their relationship with other members, either by inviting other members to join their network, or by locating existing relationships made available by the provider/keeper of the social network site or portal. Typically, connections are facilitated by sending messages (instant messages or emails) to friends who are already known or directly to people that are not known by the user. Other connections can be made through linking chains of existing relationships of people who may or may not be known to the user.

Users are more and more often invited to express their opinions and feelings, to approve or disapprove what they see, the events of the day, new products that are launched, etc.

Such applications typically provide such functions as friend-finding, same-taste-finding, community message aggregation. Very often, such applications provide a relationship map, identifying “friends of friends” who have similar tastes, similar profiles or similar characteristics.

A non-limitative list of social network sites, given just as example, without excluding any other, is: Facebook, Tweeter, Linkedin, MySpace, Orkut, Google Plus, Hi5, DeviantArt, Badoo, MeetUp, Ning, CafeMom, Tagged, LiveJournal, Friendster, Bebo, Classmates.com, delicious, Epernicus, Bich, Netlog, Plaxo.

### BRIEF SUMMARY

Having this social networking universe as background, various embodiments of this invention concern systems and methods to promote sales, making ISRs very accessible to potential buyers, in a friendly environment, giving preference to the contact buyers and ISR's within the pre-existing social network bonds. In another aspect according to various embodiments of the invention, interested individuals may easily find information and ways to become sales promoters. In still another aspect of the invention, ISR's may interact among themselves in view of best serving the buyers, in the shortest time, when physical proximity, available stock, social acquaintance or any other factor benefits the sale, with all ISR's involved splitting commissions.

According to various embodiments, a method is provided to promote sales wherein a potential buyer already participating in a specific internet social networking environment (ISNE) may access thereon a list of independent sales representatives (ISR) of certain goods or services, such that, firstly, the contact data of existing ISR's with the closest relation to the potential buyer is displayed; secondly the contact data of existing ISR's with a relation to the closest relation of the potential buyer is displayed, if any; and thirdly, the contact data of ISR's in the same physical region of the potential buyer is displayed.

In certain embodiments, the contact data of the ISR is also provided with the profile of said ISR, along with the number of recommendations given by potential buyers that already had contact with said ISR. In other various embodiments, the contact data of the ISR is also provided with the profile of said ISR, along with a message field configured for receiving and transmitting questions, ideas and comments to said ISR.

According to various embodiments, said participant in said ISNE, who already is an ISR to said goods or services, disclose said ISR condition to other participants in said ISNE. In certain embodiments, the disclosure is at least one of a badge and a splash imposed upon a picture of the participant, in his or her profile page, with the information that he or she is an ISR for a specific goods or services provider. In at least one embodiment, the picture of the participant is a profile picture of the participant on said specific internet social networking environment.

According to various embodiments, wherein a first ISR is contacted by a potential buyer and cannot provide the requested good or service, upon determination of which said first ISR contacts a second ISR to satisfy that potential buyer, and the fees related to that sale are split between first and second ISR.

### BRIEF DESCRIPTION OF THE SEVERAL VIEWS OF THE DRAWING(S)

Reference will now be made to the accompanying drawings, which are not necessarily drawn to scale, and wherein:

FIG. 1 shows an overview of one embodiment of a system that can be used to practice aspects of the present invention.

FIG. 2 shows an exemplary schematic diagram of a sales system according to an embodiment of the present invention.

### DETAILED DESCRIPTION OF VARIOUS EMBODIMENTS

Various embodiments will now be described more fully hereinafter with reference to the accompanying drawings, in which some, but not all embodiments of the inventions are shown. Indeed, the various embodiments of the present invention may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

As used in this context “independent sales representative” is an individual that is typically not an employee of the entity (company, firm, enterprise, manufacturer, store, importer, etc.) that provides goods or services for sale, but who performs sales activities, that is, intermediates sales, for a fee. For instance, as widely known, a typical activity of ISR's concerns the cosmetics industry.

“Internet social networking environments” (ISNE) concern sites on the internet or mobile that promote or allow social networking among individuals, but also comprising portals or links where a company's information is made available and/or interaction of that company with potential buyers, in many levels, is possible. The rationale is the newly detected intense social networking activity by individuals and the ease of their interaction with companies and service providers within that networking environment.

In view of the preceding, various embodiments of the invention concern systems and methods to promote sales wherein a potential buyer already participant in a specific internet social networking environment (ISNE) may access thereon a list of independent sales representatives (ISR) of certain goods or services, such that, firstly, the contact data of existing ISR's with the closest relation to the potential buyer is displayed; secondly the contact data of existing ISR's with relation to the closest relation of the potential buyer is displayed, if any; and thirdly, the contact data of ISR's in the same physical region of the potential buyer is displayed.

From the list of proposed ISRs, the profile of the chosen ISR can be accessed, in any adequate way, for instance a downloaded app, a link to another page, a widget, etc.

Optionally, the profile page of the chosen ISR, besides basic information about the person, and usual contact data (profile, address, telephone, e-mail, zip code, etc.) also contains: (1) the number of recommendations given by potential buyers that already had contact with that specific ISR; and (2) a message field where to type and send questions, ideas and comments to send to the ISR.

The feedback from the ISR to the potential buyer is performed in any adequate way, typically by email or the social network's internal messaging system.

The meaning of “closest relation” as used herein refers to individuals that are ranked as closer to the potential buyer that any others (usually referred to as “friends”). “Someone with a relation to a relation of the closest relation” as used herein concerns individuals that are not ranked as “friend”, but are known or relate to one of those “friends” (usually referred to as “friend's friend”).

The mere presence of ISRs in that specific social network site is a proximity factor that enhances the possibility of a sale, as compared to traditional sale environments, such as physical stores or online stores, where this kind of bond between sales person and buyer does not exist.

An adequate way to have access to such a list of ISR's, not excluding any other, is a link to another page or widget.

In certain embodiments of the invention, a participant in a specific internet social networking environment (ISNE), who already is an ISR to that goods or services provider, may bring that condition to the attention to other participants, so as to promptly and advantageously be introduced to potential buyers. The condition of being an ISR can be disclosed in any adequate kind, typically a badge or splash imposed upon the picture of the participant, in his or her profile page, saying for instance “Firm X's Individual Sales Representative”.

In another particular embodiment of the invention, an individual participant of that ISNE with interest in becoming an ISR has the option to contact that goods or services provider and participate in an enrolling procedure to that end. That is done in any adequate way, typically a link that leads to an online form where the interested person's data can be input and sent to the evaluation of the goods or services provides. The feed-back to this individual is done in any adequate way.

In another aspect of the invention, when a first ISR is contacted by a potential buyer and, for any reason, cannot provide the requested good or service, said first ISR contacts a second ISR, preferably of same level (for instance, potential buyer's “friend” or “friend's friend) to satisfy that potential buyer, and the fees related to that sale are split between first and second ISR.

As should be appreciated, various embodiments may be implemented in various ways, including as apparatuses, methods, systems, or computer program products. Accordingly, the embodiments may take the form of an entirely hardware embodiment or an embodiment in which one or more processors are programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

It should also be understood that various embodiments may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the various embodiments.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

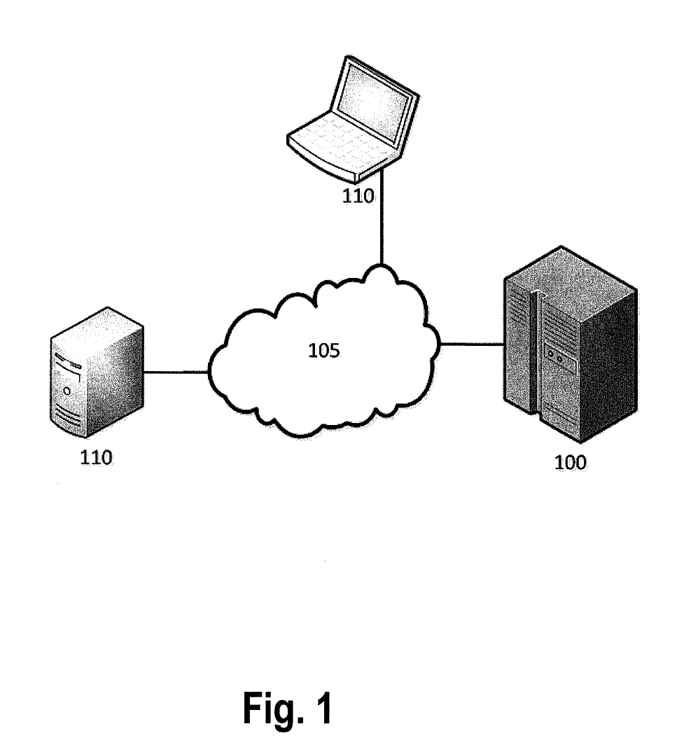

FIG. 1 provides an illustration of a system that can be used in conjunction with various embodiments of the present invention. As shown in FIG. 1, the system may include one or more sales systems 100, one or more networks 105, and one or more client/user computing entities 110. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like. Additionally, while FIG. 1 illustrates the various system entities as separate, standalone entities, the various embodiments are not limited to this particular architecture.

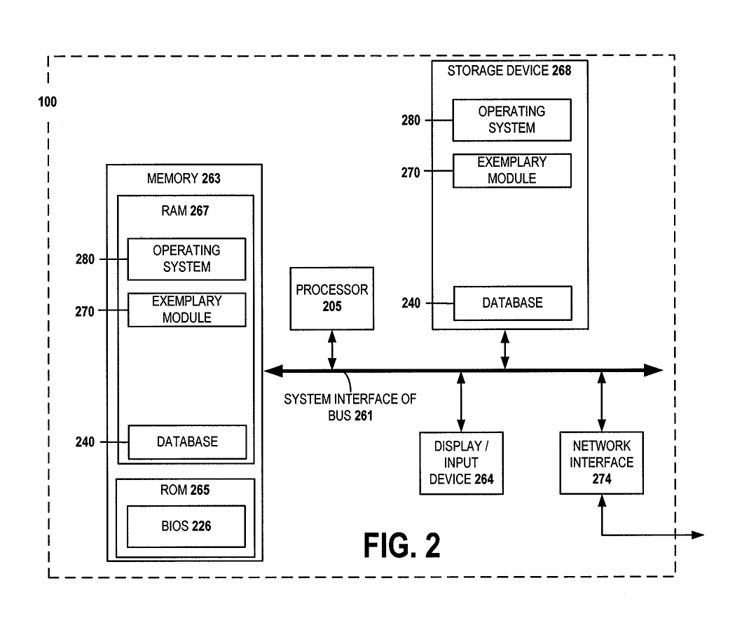

FIG. 2 provides a schematic of a sales system 100 according to one embodiment of the present invention. In general, the term “system” may refer to, for example, any computer, computing device, mobile phone, desktop, tablet, notebook or laptop, database management system, distributed system, server, blade, gateway, switch, processing device, or combination of processing devices adapted to perform the functions described herein.

As will be understood from FIG. 2, in one embodiment, the sales system 100 may include a processor 205 that communicates with other elements within the sales system 100 via a system interface or bus 261. The processor 205 may be embodied in a number of different ways. For example, the processor 205 may be embodied as a processing element, processing circuitry, a coprocessor, a controller or various other processing devices including integrated circuits such as, for example, an application specific integrated circuit (ASIC), a field programmable gate array (FPGA), a hardware accelerator, and/or the like.

In an exemplary embodiment, the processor 205 may be configured to execute instructions stored in memory or otherwise accessible to the processor 205. As such, whether configured by hardware or software methods, or by a combination thereof, the processor 205 may represent an entity capable of performing operations according to embodiments of the present invention when configured accordingly. For example, as discussed in more detail below, the sales system 100 may be configured, among other things, to process and analyze claims. A display/input device 264 for receiving and displaying data may also be included in (or in communication with) the claims system 100. This display device/input device 264 may be, for example, a keyboard or pointing device that is used in combination with a monitor (e.g., an electronic screen/display). The display/input device 264 may be a touchscreen that can detect the presence and location of a touch within the display area. The sales system 100 may further include transitory and non-transitory memory 263, which may include both random access memory (RAM) 267 and read only memory (ROM) 265. The sales system's ROM 265 may be used to store a basic input/output system (BIOS) 226 containing the basic routines that help to transfer information to the different elements within the sales system 100.

In addition, in one embodiment, the sales system 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, and/or the like. Additionally, each of these storage devices 268 may be connected to the system bus 261 by an appropriate interface.

Furthermore, a number of executable instructions, applications, scripts, program modules, and/or the like may be stored by the various storage devices 268 and/or within RAM 267. These executable instructions, applications, program modules, and/or the like may control certain aspects of the operation of the sales system 100 with the assistance of the processor 205 and operating system 280—although their functionality need not be modularized. In addition to the exemplary program modules 270, the sales system 100 may store or be in communication with one or more databases, such as database 240 storing claims processing rules.

Also located within the sales system 100, in one embodiment, is a network interface 274 for interfacing with various computing entities, including a print computing entity. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol.

Similarly, the sales system 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1x (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth^{Tm} protocols, wireless universal serial bus (USB) protocols, and/or any other wireless protocol.

It will be appreciated that one or more of the sales s system's 100 components may be located remotely from other sales system 100 components. Furthermore, one or more of the components may be combined and additional components performing functions described herein may be included in the sales system 100.

Various embodiments of the present invention may involve the use of one or more client/user computing entities 110. Generally, the term “computing entity” may refer to, for example, any computer, computing device, mobile phone, desktop, tablet, notebook or laptop, database management system, distributed system, server, blade, gateway, switch, processing device, or combination of processing devices adapted to perform the functions described herein. Accordingly, the client/user computing entity 110 may include components similar to those described with regard to the sales system 100. For example, the client/user computing entity 110 may comprise: (1) a processor that communicates with other elements via a system interface or bus; (2) a display device/input device; (3) memory including both ROM and RAM; (4) a storage device; and (5) a network interface. Similarly, a client/user computing entity 110 may comprise executable instructions, applications, scripts, program modules, and/or the like. As will be recognized, these architectures are provided for exemplary purposes only and are not limited to the various embodiments.

A person of ordinary skill in the art would be able to use the information contained in the preceding text to modify various embodiments of the invention in ways that are not literally described, but are nevertheless encompassed by the attached claims, for they accomplish substantially the same functions to reach substantially the same results. Therefore, it is to be understood that the invention is not limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method to promote sales wherein a potential buyer already participating in a specific internet social networking environment (ISNE) may access thereon a list of independent sales representatives (ISR) of certain goods or services, such that, firstly, the contact data of existing ISR's with the closest relation to the potential buyer is displayed; secondly the contact data of existing ISR's with a relation to the closest relation of the potential buyer is displayed, if any; and thirdly, the contact data of ISR's in the same physical region of the potential buyer is displayed.

2. Method according to claim 1, wherein the contact data of the ISR is also provided with the profile of said ISR, along with the number of recommendations given by potential buyers that already had contact with said ISR.

3. Method according to claim 1, wherein the contact data of the ISR is also provided with the profile of said ISR, along with a message field configured for receiving and transmitting questions, ideas and comments to said ISR.

4. Method according to claim 1, wherein said participant in said ISNE, who already is an ISR to said goods or services, disclose said ISR condition to other participants in said ISNE.

5. Method according to claim 4, wherein said disclosure is at least one of a badge and a splash imposed upon a picture of the participant, in his or her profile page, with the information that he or she is an ISR for a specific goods or services provider.

6. Method according to claim 5, wherein said picture of the participant is a profile picture of the participant on said specific internet social networking environment.

7. Method according to claim 1, wherein said individual participant of said ISNE with interest in becoming an ISR contacts said goods or services provider and participates in an enrolling procedure to that end.

8. Method according to claim 1, wherein a first ISR is contacted by a potential buyer and cannot provide the requested good or service, upon determination of which said first ISR contacts a second ISR to satisfy that potential buyer, and the fees related to that sale are split between first and second ISR.
